(19) United States
(12) Patent Application Publication
(10) Pub. No.: US 2019/0055360 A1
(43) Pub. Date: Feb. 21, 2019

(54) SULFONE POLYMER AND METHOD OF MAKING

(71) Applicant: Solvay Specialty Polymers USA, LLC, Alpharetta, GA (US)

(72) Inventors: Stéphane JEOL, Cumming, GA (US); David B. THOMAS, Atlanta, GA (US)

(21) Appl. No.: 16/078,528

(22) PCT Filed: Feb. 22, 2017
(86) PCT No.: PCT/EP2017/054094

§ 371 Date: Aug. 21, 2018

Related U.S. Application Data
(60) Provisional application No. 62/298,644, filed on Feb. 23, 2016.

(51) Int. Cl. C08G 75/23

(52) U.S. Cl. CPC C08G 75/23

(57) ABSTRACT

The invention pertains to a polyarylether sulfone polymer [polymer (PAES)] incorporating recurring units derived from well-defined amount of bi- or poly-functional monomers having identical functionalities in each of their reactive groups in a chain of units derived from of a monohalo-monohydroxyl arylsulfone monomer comprising groups of formula (A), free from hydroxyl groups which are bound to a phenyl ring comprising an activating —SO₂— group in para-position, while comprising an activated aromatic halogen bound to a phenyl ring comprising an activating —SO₂— group in para-position, having improved balance between mechanical properties and viscosity in the molten state, and endowed by lower polydispersity indexes with respect to materials of the prior art, to a method for making the same, to polymer compositions comprising the same, and to shaped articles therefrom.

This application claims priority to U.S. provisional application No. U.S. 62/298,644 filed Feb. 23, 2016, the whole content of which being incorporated herein by reference for all purposes.

### TECHNICAL FIELD

The invention pertains to a novel sulfone polymer having an improved processability/mechanical properties compromise, to a method for making the same, and to composition and shaped article therefrom.

### BACKGROUND ART

Polyarylether sulfone polymers are a well-known class of high T_{g} amorphous polymers that are used in a variety of demanding fields of use, including e.g. plumbing parts, medical devices, household appliances, structural parts in aerospace applications, smart devices, and the like.

Because of their amorphous character, it is generally understood that mechanical properties are strongly dependent upon the number of entanglements per chain, in other terms related to the length of each macromolecular chain, i.e. related to the number average molecular weight (Mₙ). Generally speaking, it is hence generally considered that the higher the number average molecular weight (Mₙ), the higher the mechanical properties.

For ensuring outstanding mechanical performances, molecular weight is generally maximized, which may have, as inevitable consequence, that polyarylether sulfone polymers exhibit such high melt viscosities that their processing, in particular for injection molding thin wall parts, may be detrimentally affected. Now, viscosity in the molten state, which is the underlying processability molecular parameter, is recognized as being dependent on the weight average molecular weight (M_{w}).

In a sense, hence, the continuous quest in the art for improving flow properties of polyaryl ether sulfone polymers while maintaining their mechanical properties, can hence be seen as a way to decrease the split between number average molecular weight (Mₙ), positively affecting mechanics, and the weight average molecular weight (M_{w}), detrimentally affecting flow behaviour, i.e. in other terms, to decrease the polydispersity index (Iₚ), that is to say the ratio M_{w}/Mₙ.

Yet, incorporation in the macromolecular chain of polyaryl ether sulfone polymers of biphenyl units of formula:

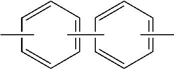

has been generally recognized as a structural mean for improving toughness of the resulting sulfone polymers.

In the domain of polyaryl ether sulfone polymeric materials, (co)polymers comprising recurring units derived from monohalo-monohydroxy-aromatic sulfone monomers including biphenyl moieties have been already disclosed in the art.

More particularly, GB 1298821 (IMPERIAL CHEMICAL INDUSTRIES LTD) Dec. 6, 1972 discloses the manufacture of polymers starting from alkali metal salt of compound of formula:

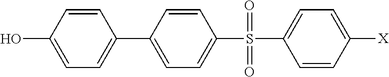

with X being a halogen (chlorine or fluorine); these compounds may be polymerized alone or copolymerized with alkali metal salts of other activated halophenols, or with mixtures of activated dihalobenzenoid compounds and an equivalent amount of alkali metal hydroxide. Exemplary embodiments include copolymers obtained from monomer as above detailed, and monomer:

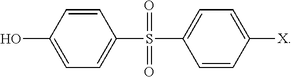

Similarly, JP 04-351636 (SAKNO CHEM CO LTD) Dec. 7, 1992 discloses copolymers obtained by copolymerizing a dihydroxy compoud, a monohalomonohydroxysulfone compound, and a dihalodiphenyl sulfone compound, in specific molar ratios, which are taught as endowed with excellent heat and chemical resistance. Working embodiment's exemplified therein are related to copolymers including recurring units derived from a monomer of formula:

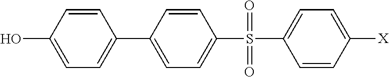

with X=Cl, and equimolecular amounts of a dihydroxy monomer (specifically 4,4′″-dihydroxyterphenyl of

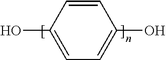

with n=3), and of a dihalodiphenyl sulfone compound (specifically: 4,4′-dichlorodiphenylsulfone of formula:

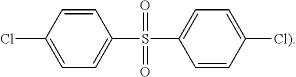

### SUMMARY OF INVENTION

The invention hereby provides for a polyaryl ether sulfone polymer possessing an improved mechanical properties/melt viscosity compromise, which is obtained by carefully selecting molar ratios between specific monohalo-monohydroxyl arylsulfone monomers, and certain specific polyfunctional compounds.

A first object of the invention is a polyaryl ether sulfone polymer [polymer (PAES)] obtained by polycondensation of a monomer mixture consisting essentially of:

(i) more than 95% moles, with respect to the total number of moles of monomers, of at least one monohalo-monohydroxyl arylsulfone monomer having formula (I):

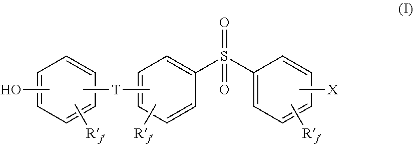

[monomer (I), herein after], wherein:
X is a halogen selected from fluorine and chlorine; preferably X is chlorine;
T is selected from the group consisting of a bond, and groups of any of formulae (A) and (B):

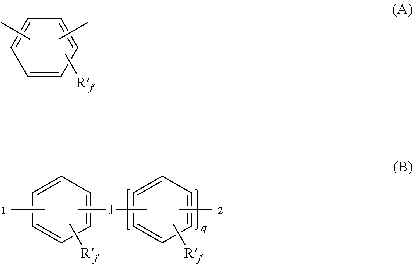

wherein the linking bond 1 in formula (B) is bound to the terminal phenyl ring bearing the hydroxyl group of formula (I), while the linking bond 2 is bound to the other phenyl ring bearing the —SO₂— group; q is zero or 1, J is a bond, or a sulfone group of formula —SO₂—;
each of R′, equal to or different from each other, is selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, alkyl phosphonate, and quaternary ammonium group;
each of j′, equal to or different from each other is zero or an integer of 1 to 4;

(ii) from 0.01 to 5% moles, with respect to the total number of moles of monomers, of at least one aryl monomer of formula (II):

Ar(P)_{z} (II) [monomer (II), herein after],

wherein:
z is an integer equal to or greater than 2;
Ar is a z-valent aromatic group, comprising one or more than one mono- or polynuclear aromatic nucleus; Ar being preferably a group of formula Ar¹-(T′-Ar²)ₙ, with each of Ar¹, and Ar², equal to or different from each other and at each occurrence, being independently an aromatic mono- or polynuclear group, and T′, equal to or different from each other and at each occurrence, is independently a bond or a divalent group optionally comprising one or more than one heteroatom; preferably T′ is selected from the group consisting of a bond, —CH₂—, —C(O)—, —C(CH₃)₂—, —C(CF₃)₂—, —C(═CCl₂)—, —SO₂—, —C(CH₃)(CH₂CH₂COOH), and n is zero or an integer of 1 to 5; wherein groups P may be connected to any of Ar¹ and Ar²;
P is at each occurrence either a hydroxyl group, or a halogen atom, with the provision that all groups P in formula (II) are identical, and when P is a halogen atom, the said P is bound to an aromatic ring possessing an electron-withdrawing group.

The Applicant has surprisingly found that the incorporation of the aforementioned well-defined amount of bi- or poly-functional monomers having identical functionalities in each of their reactive groups in a polyaryl ether sulfone polymer made of units derived from a monohalo-monohydroxyl arylsulfone monomer comprising groups of formula:

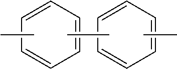

said monomer being free from hydroxyl groups bound to a phenyl ring comprising an activating —SO₂— group in para-position, and comprising an activated aromatic halogen comprising a —SO₂— group in para position, is such to provide sulfone polymeric materials having improved balance between mechanical properties and viscosity in the molten state, which are endowed by lower polydispersity indexes with respect to materials of the prior art.

Without being bound by this theory, the Applicant has tentatively found that the monomer (I), thanks to its peculiar character, is able to grown polymer chains at each reactive group of monomer (II), and, because of its “asymmetrical” structure, leads to growing chains leading to ethereal -Ph-Ph-O-Ph-SO₂— groups (with Ph being an optionally substituted phenyl group), wherein only the ethereal bond linked to the —SO₂— group is labile, and whose trans-etherification reaction with other growing polymers is beneficial to chain growing, with no hyperbranching/crosslinking effect (which are detrimental to processability and which dramatically enlarge molecular weight distribution).

The invention further pertains to a method for making polymer (PAES) as defined above, said method comprising reacting monomer (I) and monomer (II) in the presence of at least one alkali metal carbonate.

Still other objects of the invention are polymer compositions comprising the polyaryl ether sulfone polymer as defined above, and shaped articles obtained therefrom.

### BRIEF DESCRIPTION OF DRAWINGS

FIG. 1 is a graph sketching complex viscosity (in Pa·s) as a function of shear rate (in sec⁻¹) for polymer (PAES) of example 4 (solid bold line), compared to the rheological profile of polymers of examples 5C of comparison (dotted line).

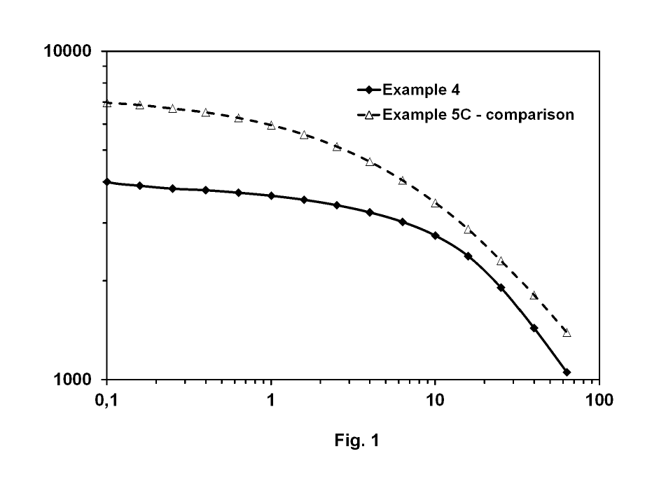

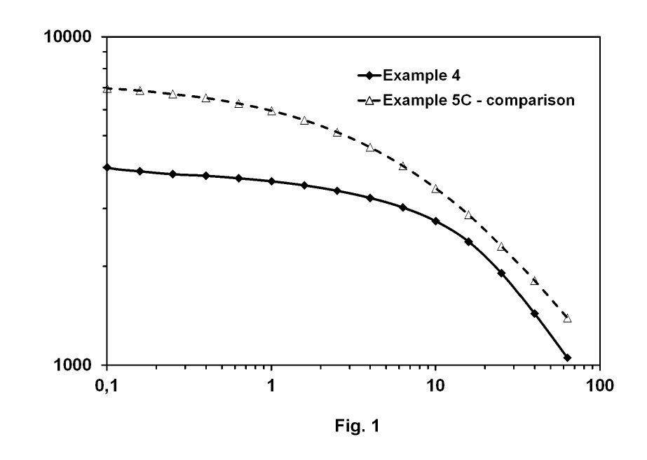

### DESCRIPTION OF EMBODIMENTS

In monomer (I), the respective phenylene moieties may independently have 1,2-, 1,4- or 1,3-linkages to the other moieties different from R′. Preferably, said phenylene moieties have 1,3- or 1,4-linkages, more preferably they have 1,4-linkage.

When P is a halogen atom, the said P is bound to an aromatic ring possessing as electron-withdrawing group preferably a —SO₂— group. The said —SO₂— group is preferably positioned in ortho or para position with respect to the said halogen atom, so as to ensure suitable activation towards nucleophilic substitution.

Hence, monomer (I) is preferably at least one selected from the group consisting of compounds of formula (I-1):

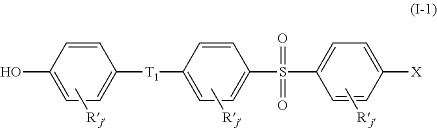

wherein:
X is a halogen selected from fluorine and chlorine; preferably X is chlorine;
T₁ is selected from the group consisting of a bond, and groups of any of formulae (A1) and (B1):

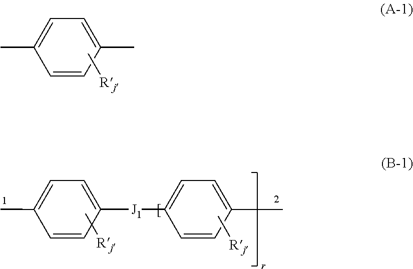

wherein:
the linking bond 1 in formula (B-1) is bound to the terminal phenyl ring bearing the hydroxyl group of formula (I), while the linking bond 2 is bound to the other phenyl ring bearing the —SO₂— group; r is zero or 1; J₁ is a bond, or a sulfone group of formula —SO₂—;
each of R′, equal to or different from each other, is selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, alkyl phosphonate, and quaternary ammonium group;
each of j′, equal to or different from each other is zero or an integer of 1 to 4.

Still, in monomer (I), j′ is at each occurrence zero, that is to say that the phenylene moieties have no other substituents than those enabling linkage in the main chain of the polymer.

Non limitative exemplary embodiment's of monomers (I) which have been found useful in the polyaryl ether sulfone polymers of the present invention are those of formulae (I-a) to (I-c) as below detailed:

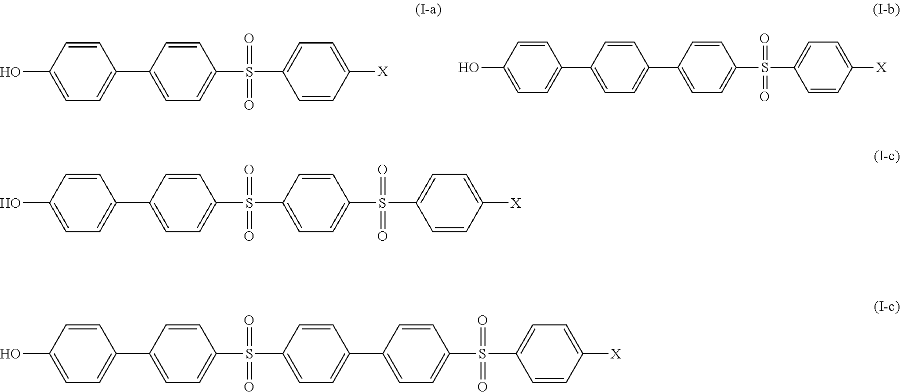

wherein X is chlorine or fluorine, preferably chlorine.

Best results have been obtained when monomer (I) was a monomer of formula (I-a) as above detailed, i.e. 4-hydroxy-4′-(4-chlorophenylsulphonyl)-biphenyl.

The monomer (II) can be selected from (j) aryl monomers of formula (II), as above detailed, wherein each of P is a hydroxyl group; and (jj) aryl monomers of formula (II), as above detailed, wherein each of P is a halogen selected from chlorine and fluorine.

According to a first embodiment of the invention, aryl monomers (II-j) are used, wherein each of P is a hydroxyl group.

Monomers (II-j) comprising 2 or more than 2 hydroxyl groups (e.g. 3 or 4 hydroxyl groups) can be used.

Among suitable monomers (II-j) comprising 2 hydroxyl groups which can be incorporated in the polymer (PAES), mention can be notably made of dihydroxyl compounds of formula (O):

HO—Ar³-(T^{O}-Ar⁴)ₙ—O—H formula (O)

wherein:
n is zero or an integer of 1 to 5;
each of Ar³ and Ar⁴, equal to or different from each other and at each occurrence, is an aromatic moiety of the formula:

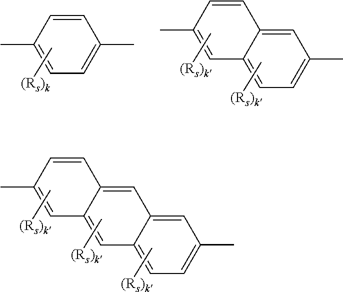

wherein:
each Rₛ is independently selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, and alkyl phosphonate, and quaternary ammonium groups; and
k is zero or an integer of 1 to 4; k′ is zero or an integer of 1 to 3;
T^{O} is a bond or a divalent group optionally comprising one or more than one heteroatom different from a —O— ethereal group; preferably T° is selected from the group consisting of a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

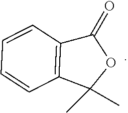

Among preferred dihydroxyl compounds of formula (0), mention may be notably made of the following molecules:

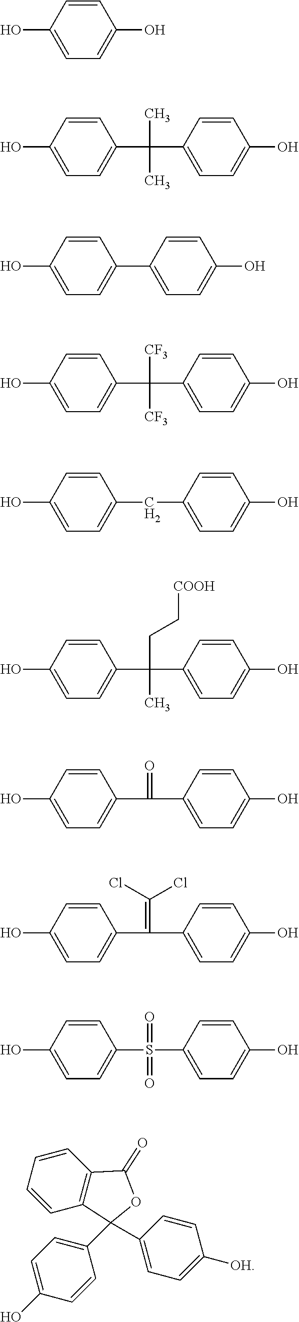

Among suitable monomers (II-j) comprising 3 hydroxyl groups which can be incorporated in the polymer (PAES), mention can be notably made of 1,3,5-tris(4-hydroxyphenyl)benzene), and trihydroxybenzenes of formula:

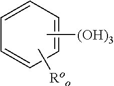

wherein each R^{o} is independently selected from the group consisting of alkyl, alkenyl, alkynyl, aryl, alkyloxy, thioalkyloxy; and o is zero or an integer equal to 1, 2 or 3. Among these compounds, 1,3,5-trihydroxy-benzene has been found particularly effective.

Monomers (II-jj) comprising 2 or more than 2 halogen atoms (e.g. 3 or 4 halogen atoms) can be used, and are generally preferred.

Among suitable monomers (II-jj) comprising 2 halogen atoms which can be incorporated in the polymer (PAES), mention can be notably made of dihaloaryl compounds of formula (S):

X—Ar⁵—SO₂—[Ar⁶-(T^{S}-Ar⁷)ₙ—SO₂]ₘ—Ar⁸—X′ formula (S)

wherein
n and m, equal to or different from each other, are independently zero or an integer of 1 to 5; X and X′, equal to or different from each other, are halogens selected from F, CI; preferably CI;
each of Ar⁵, Ar⁶, Ar⁷ and Ar⁸ equal to or different from each other and at each occurrence, is a mononuclear or polynuclear aromatic moiety;
T^{S} is a bond or a divalent group selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula:

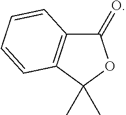

The mononuclear or polynuclear aromatic moiety represented by any of Ar⁵, Ar⁶, Ar⁷ and Ar⁸, equal to or different from each other and at each occurrence, is preferably complying with following formulae:

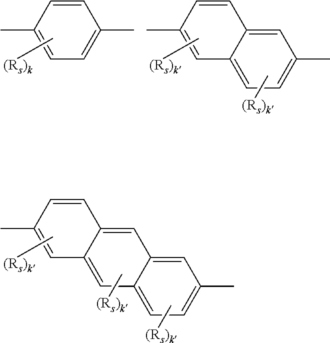

wherein:
each Rₛ, equal to or different from each other, is independently selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, alkyl phosphonate and quaternary ammonium gruops; and
k is zero or an integer of 1 to 4; k′ is zero or an integer of 1 to 3.

Preferred dihaloaryl compounds of formula (S) are those complying with formulae (S-1) to (S-3), as shown below:

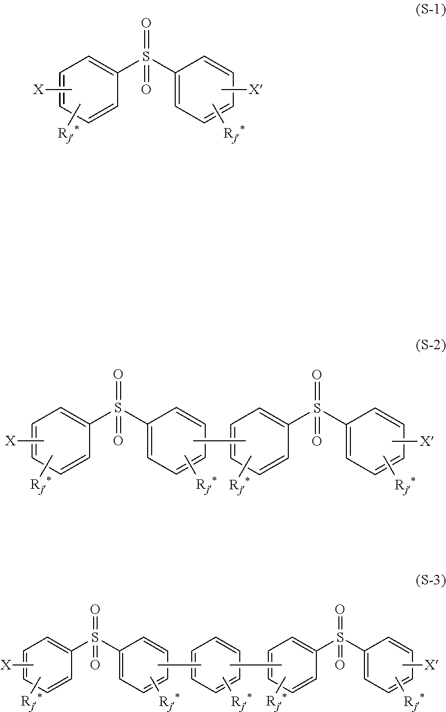

wherein:
each of R*, equal to or different from each other, is independently selected from the group consisting of alkyl, alkenyl, alkynyl, aryl, alkyloxy, aryloxy, thioalkyloxy, thioaryloxy, carboxylic acid, ester, amide, imide, alkali or alkaline earth metal sulfonate, alkyl sulfonate, alkali or alkaline earth metal phosphonate, alkyl phosphonate and quaternary ammonium salt;
j′ is zero or is an integer from 0 to 4;
X and X′, equal to or different from each other, are independently a halogen atom, preferably CI or F.

More preferred dihaloaryl compounds of formula (S) are those complying with following formulae shown below:

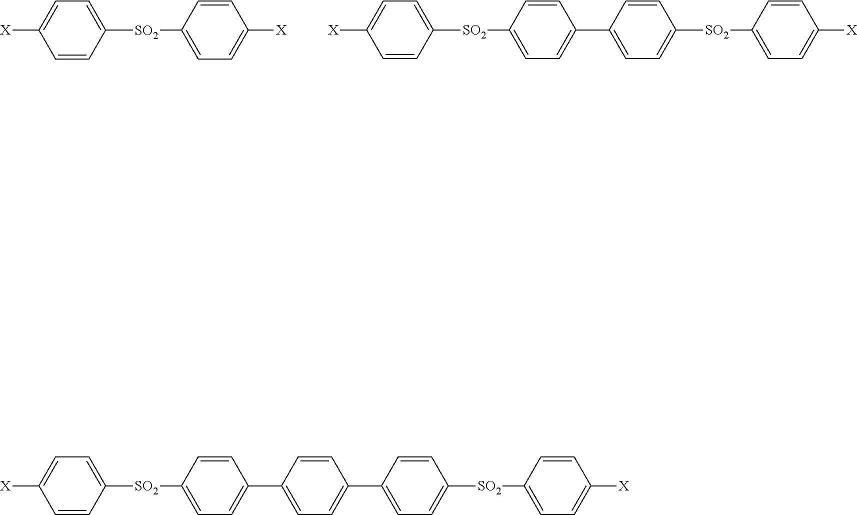

wherein X is as defined above, X is preferably CI or F.

Most preferred dihaloaryl compounds (S) are 4,4′-difluorodiphenyl sulfone (DFDPS) and 4,4′-dichlorodiphenyl sulfone (DCDPS).

Among suitable monomers (II-jj) comprising more than 2 halogen atom, mention can be notably made of 1,3,5-tris((4-chlorophenyl)sulfonyl)benzene.

The polymer (PAES), prepared by the process of the present invention, has in general a weight averaged molecular weight of at least 20 000, preferably at least 30 000, more preferably at least 40 000 g/mol.

The weight average molecular weight (M_{w}) and the number average molecular weight (Mₙ) of polymer (PAES) can be determined by gel-permeation chromatography (GPC) following general procedure described in ASTM D5296, typically using dichloromethane as solvent, and calibration curve based on polystyrene standards.

The weight average molecular weight (M_{w}) is:

$${M}_{w} = \frac{\sum {M}_{i}^{2} \cdot {N}_{i}}{\sum {M}_{i} \cdot {N}_{i}}$$

wherein Mᵢ is the molecular weight of the polymer chain i, and Nᵢ is the number of polymer chains i having the said molecular weight Mᵢ.

The number average molecular weight (Mₙ):

$${M}_{n} = \frac{\sum {M}_{i} \cdot {N}_{i}}{\sum {N}_{i}}$$

wherein Mi and Ni have the meaning as above detailed.

The polydispersity index (Iₚ) is hereby defined as the ratio of weight average molecular weight (M_{w}) to number average molecular weight (Mₙ), i.e.

$${I}_{p} = \frac{{M}_{w}}{{M}_{n}} .$$

The polymer (PAES) generally has a number averaged molecular weight (Mₙ) of at least 10 000, preferably at least 12 000, more preferably at least 14 000, even more preferably at least 15 000 g/mol. Upper boundary for Mₙ will be optimized in view of improving mechanical properties, taking into account processability requirements for the intended field of use. It is generally acknowledged that polymers (PAES) useful within the frame of the present invention will typically possess a Mₙ of at most 100 000, preferably at most 80 000, even more preferably at most 60 000 g/mol.

The polymer (PAES) generally has a polydispersity index (Iₚ) of less than about 2.5, preferably of less than about 2.4. This relatively narrow molecular weight distribution is representative of an ensemble of molecular chains with similar molecular weights and substantially free from both oligomeric fractions and from high molecular weight tails, which might have a detrimental effect on polymer properties.

As said above, polymer (PAES) results from the polycondensation of a monomer mixture essentially consisting of monomer (I) and monomer (II); impurities, defects or very minor amounts (less than 0.1% moles, with respect to overall monomers mixture) of other monomers may be present, without these significantly affecting properties of polymer (PAES). It is generally understood, nevertheless, that purity of monomer (I) and monomer (II) will be selected so as to minimize presence of impurities and defects, and that monomers different from monomer (I) and monomer (II) are avoided as much as possible.

With regards to the molar ratio between monomer (I) and monomer (II), as said above, polymer (PAES) is obtained by reacting an amount of monomer (II) of at least 0.01% moles, preferably at least 0.1% moles, more preferably at least 0.25% moles, with respect to the total number of moles of monomers, the complement thereof to 100% being monomer (I). Yet, polymer (PAES) is obtained by reacting an amount of monomer (II) of at most 5% moles, preferably at most 3% moles, more preferably at most 2% moles, with respect to the total number of moles of monomers, the complement thereof to 100% being monomer (I).

The molar percentage of monomers (I) and (II) is adapted within the aforementioned ranges so as to optimize the gain in processability without affecting mechanical properties. Amounts of monomer (II) below the aforementioned lower boundaries are not effective in achieving optimal improvements in processability, while amounts of monomer (II) beyond the recited upper boundaries may affect the overall macromolecular structure of the polyeryl ether sulfone, including detrimentally affecting notably mechanical properties and/or chemical and/or thermal resistance.

According to preferred embodiments of the method of the present invention, monomer (I) and monomer (II) are reacted while dissolved or dispersed in a solvent mixture comprising a polar aprotic solvent.

As polar aprotic solvents, sulphur containing solvents known and generically described in the art as dialkyl sulfoxides and dialkylsulfones wherein the alkyl groups may contain from 1 to 8 carbon atoms, including cyclic alkylidene analogs thereof, can be mentioned. Specifically, among the sulphur-containing solvents that may be suitable for the purposes of this invention are dimethylsulfoxide, dimethylsulfone, diphenylsulfone, diethylsulfoxide, diethylsulfone, diisopropylsulfone, tetrahydrothiophene-1,1-dioxide (commonly called tetramethylene sulfone or sulfolane) and tetrahydrothiophene-1-monoxide and mixtures thereof.

Very good results have been obtained with sulfolane.

Nitrogen-containing polar aprotic solvents, including dimethylacetamide, dimethylformamide and N-methyl pyrrolidone (i.e., NMP) and the like have been disclosed in the art for use in these processes, and may also be found useful in the practice of this invention. Very good results have been obtained with NMP.

If desired, an additional solvent can be used together with the polar aprotic solvent which forms an azeotrope with water, whereby water formed as a by-product during the polymerization may be removed by continuous azeotropic distillation throughout the polymerization.

The by-product water and carbon dioxide possibly formed during the polymerization can alternatively be removed using a controlled stream of an inter gas such as nitrogen or argon over and/or in to the reaction mixture in addition to or advantageously in the absence of an azeotrope-forming solvent as described above.

For the purpose of the present invention, the term “additional solvent” is understood to denote a solvent different from the polar aprotic solvent and the reactants and the products of said reaction.

The additional solvent that forms an azeotrope with water will generally be selected to be inert with respect to the monomer components and polar aprotic solvent. Suitable azeotrope-forming solvents for use in such polymerization processes include aromatic hydrocarbons such as benzene, toluene, xylene, ethylbenzene, chlorobenzene and the like.

The azeotrope-forming solvent and polar aprotic solvent are typically employed in a weight ratio of from about 1:10 to about 1:1, preferably from about 1:5 to about 1:3.

The alkali metal carbonate is preferably lithium carbonate, sodium carbonate, potassium carbonate, rubidium carbonate and cesium carbonate. Sodium carbonate and especially potassium carbonate are preferred. Mixtures of more than one carbonates can be used, for example, a mixture of sodium carbonate or bicarbonate and a second alkali metal carbonate or bicarbonate having a higher atomic number than that of sodium.

The amount of said alkali metal carbonate used, when expressed by the ratio of the equivalents of alkali metal (M) per equivalent of hydroxyl group (OH) [eq. (M)/eq. (OH)] ranges from 1.01 to 2.00, preferably from 1.02 to 1.5, and more preferably from about 1.03 to 1.25, being understood that above mentioned hydroxyl group equivalents are comprehensive of those of the monomer (I), and, if present, of monomer (II). Very good results have been obtained with a ratio of eq. (M)/eq. (OH) of about 1.05.

The use of an alkali metal carbonate having an average particle size of less than about 100 μm, preferably of less than about 50 μm is particularly advantageous. The use of an alkali metal carbonate having such a particle size permits the synthesis of the polymers to be carried out at a relatively lower reaction temperature with faster reaction.

According to a preferred embodiment of the present invention, the method comprises reacting monomer (I) and monomer (II) in a solvent mixture comprising a polar aprotic solvent at a total % solids, (i.e. comprehensive of polymer produced from monomer (I) and monomer (II)) ranging from 20% to 40%, preferably from 25% to 35%, more preferably from 28% and 32%, with respect to the total weight of polymer produced from monomers (I) and (II) and solvent mixture.

Generally, after an initial heat up period, the temperature of the reaction mixture will be maintained in a range of advantageously from 80-300° C., preferably from 120 to 240° C., and more preferably from 120 to 230° C.

The reaction time is typically from 2 to 20 hours, preferably from 3 to 12 hours, most preferably from 4 to 6 hours.

When the reaction reaches the targeted molecular weight, unreacted hydroxyl end-groups may be converted into unreactive species by reaction with a suitable end-capping agent, typically a mono-chloro organic compound, for instance by bubbling methyl chloride in the reaction mixture.

Yet another object of the present invention is a polyaryl ether sulfone polymer composition [composition (C)] comprising at least one polymer (PAES) as above detailed, and at least one additional ingredient selected from the group consisting of polymers different from polymer (PAES), lubricating agents, UV-stabilizers, heat stabilizers, anti-static agents, extenders, reinforcing agents, organic and/or inorganic pigments, acid scavengers, antioxidants, flame retardants, smoke-suppressing agents.

The polymer different from polymer (PAES) can be notably a polyaryl ether sulfone polymer different from polymer (PAES) or can be a different type of polymer, e.g. a polaryl ether ketone polymer, a polyamide, a polyphenylsulfide polymer, a polyimide polymer, and the like.

Generally the said reinforcing agent is selected from the group consisting of non-fibrous reinforcing fillers, fibrous fillers and mixtures thereof. Fibrous fibers may include glass fiber, carbon or graphite fibers, and fibers formed of silicon carbide, alumina, titania, boron and the like, and may include mixtures comprising two or more such fibers. Non-fibrous reinforcing fillers include notably talc, mica, titanium dioxide, potassium titanate, silica, kaolin, chalk, alumina, mineral fillers, and the like.

Another aspect of the present invention concerns a method of manufacturing the polyaryl ether sulfone polymer composition as above described, said method comprising mixing the at least one polymer (PAES), and the said at least one additional ingredient.

Advantageously, the method comprises mixing by dry blending and/or melt compounding the at least one polymer (PAES), and the said at least one additional ingredient. Preferably, the method comprises mixing by melt compounding, notably in continuous or batch devices. Such devices are well-known to those skilled in the art.

Examples of suitable continuous devices to melt compound the composition (C) are notably screw extruders. Thus, the said at least one polymer (PAES), and the said at least one additional ingredient are advantageously fed in powder or granular form in an extruder and the polymer composition is advantageously extruded into strands and the strands are advantageously chopped into pellets.

Preferably, melt compounding is carried out in a twin-screw extruder.

The polymer (PAES) and/or the composition (C) can be processed following standard methods for injection molding, extrusion, thermoforming, machining, and blow molding, when aiming at manufacturing shaped articles. Solution-based processing for coatings and membranes is also possible. Shaped articles comprising the polymer (PAES) or the composition (C) can undergo standard post-fabrication operations such as ultrasonic welding, adhesive bonding, and laser marking as well as heat staking, threading, and machining.

Still an object of the invention is a shaped article comprising the polymer (PAES) or the composition (C), as above detailed.

Advantageously, the article is an injection molded article, an extrusion molded article, a shaped article, a coated article or a casted article.

Non-limitative examples of shaped articles are notably electronic components (such as printed circuit boards, electrical plug-in connectors, bobbins for relays and solenoids), structural parts and housing of appliances and/or of mobile devices, pipes, fittings, housings, films, membranes, coatings, composites, in particular including fabrics or nonwoven mats of glass fibers or carbon fibers.

The invention will be now described in more details with reference to the following examples, whose purpose is merely illustrative and not intended to limit the scope of the invention.

### Raw Materials

4-hydroxy-4′-(4-chlorophenylsulphonyl)-biphenyl having a purity of at least 99% was supplied from Sanko Chemicals and used as received [monomer (I-X), hereinafter]

4-hydroxy-4′-chloro-diphenylsulfone (HCDPS, CAS: 7402-67-7) having a purity of at least 99% was synthesized according to literature.

1,3,5-trihydroxy-benzene (phloroglucinol) having a purity of at least 99% was supplied from Sigma-Aldrich and used as received [monomer (II-(OH)₃), hereinafter]

4,4′-Dichlorodiphenyl sulfone having a purity of at least 99% was supplied from Solvay and used as received [monomer (II-Cl₂), hereinafter]

Sulfolane having a purity of at least 99.9% was supplied from Chevron Phillips and used as received.

Monochlorobenzene (MCB) having a purity of at least 99.5% was supplied from Sigma-Aldrich and used as received

Potassium carbonate EF-80 having a purity of at least 99.5% was supplied from UNID and was dried at 140 C before use.

### General Description of the Method of Making Polymer (PAES)

### For Examples 1, 2, 3 and 1C, 2C, 3C and 4C of Comparison

To a clean 250 mL four-neck round bottom flask fitted with a mechanical stirrer, Dean-Stark trap, condenser, and nitrogen inlet, was placed the required amounts of monomer (I) and (II), and potassium carbonate followed by the polar aprotic solvent (sulfolane) and optionally the additional solvent (monochlorobenzene) targeting a solids content of 30% wt. A slight stream of nitrogen was applied above the reaction mixture through one of the necks of the flask with an exit through a bubbler above the condenser. The reaction mixture was stirred with an overhead mechanical agitator and warmed using an oil bath controlled at the appropriate temperature. The bath temperature increased from 21° C. to the appropriate temperature over about 30-60 minutes and held at the reaction temperature for a desired period of time The reaction mixture was quickly cooled down to 150° C., diluted with NMP, further cooled to <100° C., and the mixture poured in to a Waring blender containing 500 mL of a 50/50 v/v mixture of water and methanol. The resulting off-white porous solid was then isolated by filtration, and washed three times in the Waring blender with hot DI water (−70° C.) and twice with methanol with filtration between each wash. The resulting porous, off-white polymer solid was dried in a vacuum oven overnight at 80° C. The polymer solid was further analyzed by GPC to determine the molecular weight parameters (M_{w}, Mₙ, and Iₚ) (all reaction conditions and results are summarized in Tables).

### For Examples C5 and Example 4

Similar procedure than above was followed but a 1 L reactor was used instead and after the desired period of time, methyl chloride gas was bubbled into the reaction mixture at a rate of 1 g/min to convert all of the residual phenoxides groups into methoxy end-groups for 15-30 min at the polymerization temperature. The polymer was recovered in the same manner as described above. The polymer solids were analysed by GPC to determine the molecular weights and polydispersity index, by DSC to determine the thermal properties and by rheology (plate-plate) to determine the complex viscosity at 360 C at shear rates of 0.1, 1, 10 and 63 s⁻¹. The polymer solids were shaped into ASTM type V tensile bars using the DSM Xplore® injection molding with the barrel temperature set at 400 C and the mold temperature set at 190 C. The mechanical properties are evaluated by tensile measurements according to ASTM D638 standard.

TABLE 1

| | |
|---|---|
| Mono-halo monohydroxy | Polyhalo or polyhydroxy |
| monomer | monomer |

| Run | type | mol | type | mol |
|---|---|---|---|---|
| 1C | HCDPS | 1 | — | — |
| 2C | HCDPS | 1 | (II-Cl₂) | 0.075 |
| 3C | HCDPS | 1 | (II-(OH)₃) | 0.005 |
| 4C | I-X | 1 | — | — |
| 1 | I-X | 1 | (II-Cl₂) | 0.0075 |
| 2 | I-X | 1 | (II-Cl₂) | 0.015 |
| 3 | I-X | 1 | (II-(OH)₃) | 0.005 |
| 5C | I-X | 1 | — | — |
| 4 | I-X | 1 | (II-Cl₂) | 0.015 |

TABLE 2

| | K₂CO₃ | T | | t |
|---|---|---|---|---|
| Run | eq(M)/eq(OH) | (° C.) | solvent | (h) |
| 1C | 1.05 | 225 | Sulfolane/MCB 2/1 v/v | 4 |
| 2C | 1.05 | 225 | Sulfolane/MCB 2/1 v/v | 4 |
| 3C | 1.05 | 225 | Sulfolane/MCB 2/1 v/v | 4 |
| 4C | 1.05 | 220 | Sulfolane | 2 |
| 1 | 1.05 | 220 | Sulfolane | 2 |
| 2 | 1.05 | 220 | Sulfolane | 2 |
| 3 | 1.05 | 220 | Sulfolane | 2 |
| 5C | 1.05 | 220 | Sulfolane | 0.5 |
| 4 | 1.05 | 220 | Sulfolane | 2 |

TABLE 3

| | Mₙ | M_{w} | | T_{g} |
|---|---|---|---|---|
| Run | (g/mol) | (g/mol) | Iₚ | (° C.) |
| 1C | 17500 | 55120 | 3.15 | N.D. |
| 2C | 17160 | 66780 | 3.89 | N.D. |
| 3C | 16640 | 61160 | 3.68 | N.D. |
| 4C | 17130 | 43040 | 2.51 | N.D. |
| 1 | 15640 | 35900 | 2.30 | N.D. |
| 2 | 21130 | 47020 | 2.23 | N.D. |
| 3 | 15870 | 38550 | 2.43 | N.D. |
| 5C | 19420 | 48990 | 2.52 | 260 |
| 4 | 19750 | 41210 | 2.09 | 260 |

TABLE 4

| Run | 5C | 4 |
|---|---|---|
| Tensile modulus in MPa | 2720 +/− 140 | 2520 +/− 60 |
| Tensile strength at yield in MPa | 90.2 +/− 0.2 | 88.3 +/− 0.1 |
| Elongation at yield in % | 8.1 +/− 0.6 | 8.3 +/− 0.5 |
| Complex viscosity (360° C., 0.1 s⁻¹) | 6960 | 4000 (−43%) |
| in Pa · s | | |
| Complex viscosity (360° C., 1 s⁻¹) | 5950 | 3630 (−39%) |
| in Pa · s | | |
| Complex viscosity (360° C., 10 s⁻¹) | 3450 | 2740 (−21%) |
| in Pa · s | | |
| Complex viscosity (360° C., 63 s⁻¹) | 1390 | 1050 (−24%) |
| in Pa · s | | |

Comparative example 1C describes a polyarylether sulfone synthesized from HCDPS in presence of potassium carbonate and serves as a reference (PES reference, hereinafter). As polymerized in above detailed conditions, this polymer possesses a number average molecular weight Mₙ of 17500 g/mol with a polydispersity index of 3.15. By introducing 0.75 mol.-% of DCDPS (comparative example 2C) or 0.5 mol.-% of phlorogucinol (comparative example 3C), it has been observed that the number average molecular weight Mₙ did not change but the weight average molecular weight M_{w} significantly increased, causing hence a sharp increase in the polydispersity index increases (respectively to 3.89 and 3.68). These polymers were hence found to be more viscous than the PES reference (comparative example 1C): no improvement in melt flow was achieved. It was hence concluded that halophenol monomers such as HCDPS, comprising “symmetrical” ethereal bonds of type —SO₂-Ph-O-Ph-SO₂— when polymerized by modification with a polyfunctional hydroxyl or activated chlorine cannot are not effective in delivering polyaryl ether sulfone polymers possessing narrower molecular weight distribution; rather, with these monomers, polydispersity index increases, with detrimental effects on processability.

In comparative example 4C, halophenol (I-x) was polymerized in the presence of potassium carbonate, and in the absence of any modifying monomer, so as to establish a reference polyaryl ether sulfone made of units (I-x). As polymerized in above detailed conditions, this polymer possesses a number average molecular weight Mₙ of 17130 g/mol with a polydispersity index of 2.51.

By modifying polyaryl ether sulfone made of units (I-x) through co-polymerization with 0.75 mol.-% of DCDPS (example 1), 1.5 mol.-% of DCDPS (example 2) or 0.5 mol.-% of phlorogucinol (example 3), a significant decrease in polydispersity index was observed, this decrease being more significant the higher the content of polyfunctional monomer (II) used as modifier.

To compare the melt viscosity and the mechanical properties of the polyaryl ether sulfone made of units (I-x) made in the presence of a polyfunctional monomer (II) (1.5 mol.-% of DCDPS; example 4) and in the absence thereof (comparative example 5C), larger scale samples were prepared, and end-capped with methylene chloride before analytical determination.

The GPC analysis confirmed that the polymer of Ex. 4 exhibited a lower polydispersity index and, at the same times, a similar number average molecular weight Mₙ. The mechanical properties evaluated by tensile measurements were substantially similar, while a significant improvement in flow properties was evidenced, as notably shown by a reduction of the melt viscosity at all shear rates (up to about 40%).

These examples confirm that the incorporation of given and controlled amounts of specific polyfunctional hydroxyl or activated chlorine monomers during polycondensation of specific halophenol monomers is particularly effective for improving melt flow properties (hence processability) while maintaining substantially un-modified the outstanding mechanical performances.

Should the disclosure of any patents, patent applications, and publications which are incorporated herein by reference conflict with the description of the present application to the extent that it may render a term unclear, the present description shall take precedence.

1-15. (canceled)

16. A polyaryl ether sulfone polymer, polymer (PAES), obtained by polycondensation of a monomer mixture consisting essentially of:
(i) more than 95% moles, with respect to the total number of moles of monomers, of at least one monohalo-monohydroxyl arylsulfone monomer having formula (I): 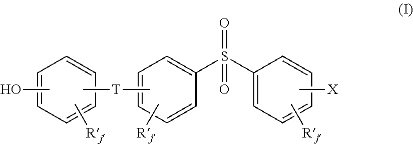
wherein:
X is a halogen selected from fluorine and chlorine;
T is selected from the group consisting of a bond, and groups of any of formulae (A) and (B): 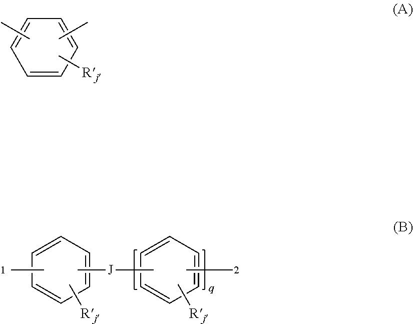
wherein the linking bond 1 in formula (B) is bound to the terminal phenyl ring bearing the hydroxyl group of formula (I), while the linking bond 2 is bound to the other phenyl ring bearing the —SO₂— group; q is zero or 1, J is a bond, or a sulfone group of formula —SO₂—;
each of R′, equal to or different from each other, is selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, alkyl phosphonate, and quaternary ammonium group;
each of j′, equal to or different from each other is zero or an integer of 1 to 4;
(ii) from 0.01 to 5% moles, with respect to the total number of moles of monomers, of at least one aryl monomer of formula (II):
Ar(P)_{z} (II)
wherein:
z is an integer equal to or greater than 2;
Ar is a z-valent aromatic group, comprising one or more than one mono- or polynuclear aromatic nucleus;
P is at each occurrence either a hydroxyl group, or a halogen atom, with the provision that all groups P in formula (II) are identical, and when P is a halogen atom, the said P is bound to an aromatic ring possessing an electron-withdrawing group.

17. The polymer (PAES) of claim 16, wherein the monomer of formula (I) is at least one compound selected from the group consisting of compounds of formula (I-1): 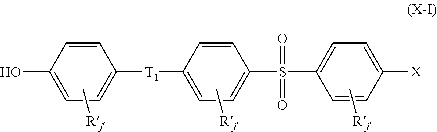
wherein:
X is a halogen selected from fluorine and chlorine;
T₁ is selected from the group consisting of a bond, and groups of any of formulae (A1) and (B1): 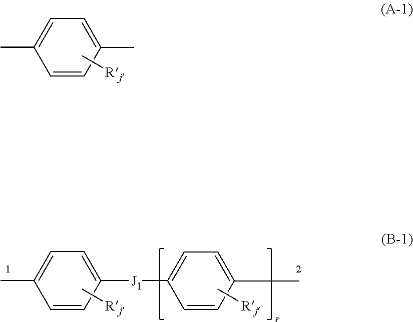
wherein:
the linking bond 1 in formula (B-1) is bound to the terminal phenyl ring bearing the hydroxyl group of formula (I), while the linking bond 2 is bound to the other phenyl ring bearing the —SO₂— group; r is zero or 1; J₁ is a bond, or a sulfone group of formula —SO₂—;
each of R′, equal to or different from each other, is selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, alkyl phosphonate, and quaternary ammonium group; and
each of j′, equal to or different from each other is zero or an integer of 1 to 4.

18. The polymer (PAES) of claim 17, wherein the monomer of formula (I) is at least one compound of formulae (I-a) to (I-d): 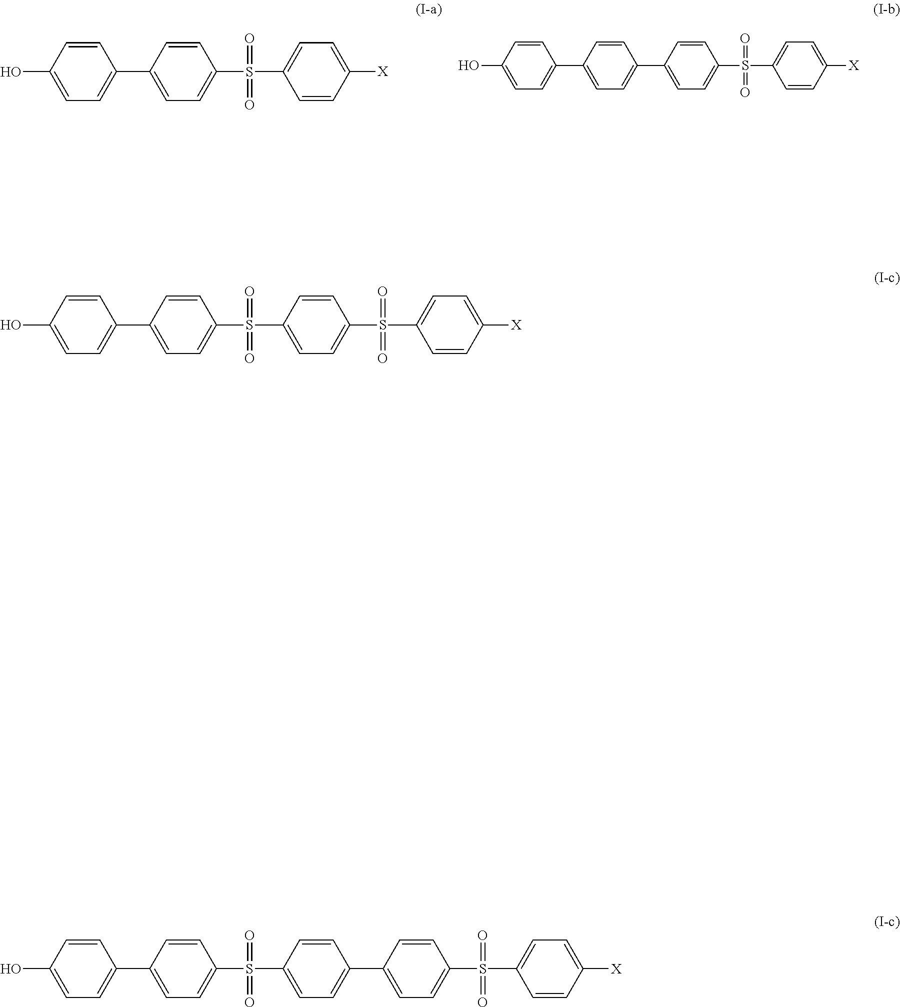
wherein X is chlorine or fluorine.

19. The polymer (PAES) of claim 18, wherein the monomer of formula (I) is formula (I-a).

20. The polymer (PAES) of claim 16, wherein the monomer of formula (II) is selected from (j) aryl monomers of formula (II), wherein each of P is a hydroxyl group.

21. The polymer (PAES) of claim 20, wherein the monomer of formula (II) comprises 2 or 3 hydroxyl groups, and wherein:
(1) monomer (II-j) comprising 2 hydroxyl groups is selected from the group consisting of dihydroxyl compounds of formula (O):
HO—Ar³-(T^{O}-Ar⁴)ₙ—O—H (O)
wherein:
n is zero or an integer of 1 to 5;
each of Ar³ and Ar⁴, equal to or different from each other and at each occurrence, is an aromatic moiety of the formula: 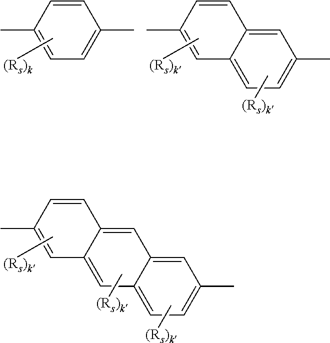
wherein:
each Rₛ is independently selected from the group consisting of alkyl, alkenyl, alkynyl, aryl, alkyloxy, thioalkyloxy, carboxylic acid, alkali or alkaline earth metal sulfonate, alkyl sulfonate, alkali or alkaline earth metal phosphonate, and alkyl phosphonate, and quaternary ammonium groups; and
k is zero or an integer of 1 to 4;
k′ is zero or an integer of 1 to 3;
T^{O} is a bond or a divalent group optionally comprising one or more than one heteroatom different from a —O— ethereal group;
and
(2) monomer (II-j) comprising 3 hydroxyl groups is selected from the group consisting of 1,3,5-tris(4-hydroxyphenyl)benzene), and trihydroxybenzenes of formula: 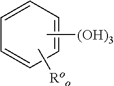
wherein each R^{o} is independently selected from the group consisting of alkyl, alkenyl, alkynyl, aryl, alkyloxy, thioalkyloxy; and o is zero or an integer equal to 1, 2 or 3.

22. The polymer (PAES) of claim 16, wherein the monomer of formula (II) is selected from (j) aryl monomers of formula (II), wherein each of P is a halogen atom.

23. The polymer (PAES) of claim 22, wherein the monomer of formula (II) comprises 2 or 3 halogen atoms, and wherein:
(1) monomer (II-jj) comprising 2 halogen atoms is selected from the group consisting of dihaloaryl compounds of formula (S):
X—Ar⁵—SO₂—[Ar⁶-(T^{S}-Ar⁷)ₙ—SO₂]ₘ—Ar⁸—X′ (S)
wherein:
n and m, equal to or different from each other, are independently zero or an integer of 1 to 5; X and X′, equal to or different from each other, are halogens selected from F and CI;
each of Ar⁵, Ar⁶, Ar⁷ and Ar⁸ equal to or different from each other and at each occurrence, is a mononuclear or polynuclear aromatic moiety;
T^{S} is a bond or a divalent group selected from the group consisting of a bond, —CH₂—, —C(O)—, —C(CH₃)₂—, —C(CF₃)₂—, —C(═CCl₂)—, —C(CH₃)(CH₂CH₂COOH)—, and a group of formula: 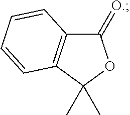
(2) monomer (II-jj) comprising 3 halogen atom is 1,3,5-tris((4-chlorophenyl)sulfonyl)benzene.

24. The polymer (PAES) of claim 23, wherein the monomer of formula (II) is selected from: 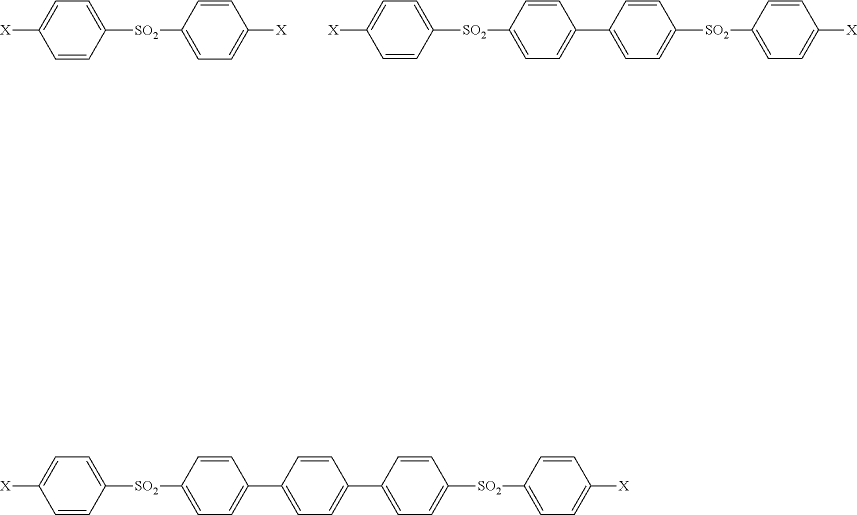
wherein X is Cl or F.

25. The polymer (PAES) according to claim 16, wherein the polymer (PAES) is obtained by polycondensation of at least 0.1% moles of the monomer of formula (II), with respect to the total number of moles of monomers, the complement thereof to 100% being monomer of formula (I), and/or the polymer (PAES) is obtained by reacting an amount of at most 3% moles of the monomer of formula (II) of, with respect to the total number of moles of monomers, the complement thereof to 100% being monomer of formula (I).

26. The polymer (PAES) according to claim 16, wherein the polymer (PAES) has a polydispersity index (Iₚ) of less than about 2.5.

27. A method for making the polymer (PAES) according to claim 16, the method comprising reacting the monomer of formula (I) and the monomer of formula (II) in the presence of at least one alkali metal carbonate, wherein the amount of said alkali metal carbonate, when expressed by the ratio of the equivalents of alkali metal (M) per equivalent of hydroxyl group (OH) of the monomer of formula (I) and the monomer of formula (II) [eq. (M)/eq. (OH)] ranges from 1.01 to 2.00.

28. A polyaryl ether sulfone polymer composition, composition (C), comprising at least one polymer (PAES) according to claim 16, and comprising at least one additional ingredient selected from the group consisting of: polymers different from the polymer (PAES), lubricating agents, UV-stabilizers, heat stabilizers, anti-static agents, extenders, reinforcing agents, organic and/or inorganic pigments, acid scavengers, antioxidants, flame retardants, smoke-suppressing agents, and combinations thereof.

29. A method of manufacturing the polyaryl ether sulfone polymer composition (C) of claim 28, wherein the method comprises mixing the at least one polymer (PAES), and the at least one additional ingredient.

30. A shaped article comprising the polymer (PAES) according to claim 16, wherein the shaped article is selected from the group consisting of electronic components, structural parts and housing of appliances and/or of mobile devices, pipes, fittings, housings, films, membranes, coatings, composites having fabrics or nonwoven mats of glass fibers or carbon fibers.

31. The polymer (PAES) according to claim 16, wherein Ar is a group of formula Ar¹-(T′-Ar²)ₙ, with each of Ar¹, and Ar², equal to or different from each other and at each occurrence, being independently an aromatic mono- or polynuclear group, and T′, equal to or different from each other and at each occurrence, is independently a bond or a divalent group optionally comprising one or more than one heteroatom, n is zero or an integer of 1 to 5, and wherein groups P may be connected to any of Ar¹ and Ar².

32. The polymer (PAES) according to claim 31, wherein T′ is selected from the group consisting of a bond, —CH₂—, —C(O)—, —C(CH₃)₂—, —C(CF₃)₂—, —C(═CCl₂)—, —SO₂—, and —C(CH₃)(CH₂CH₂COOH).

33. The polymer (PAES) according to claim 21, wherein T° is selected from the group consisting of a bond, —SO₂—, —CH₂—, —C(O)—, —C(CH₃)₂—, —C(CF₃)₂—, —C(═CCl₂)—, —C(CH₃)(CH₂CH₂COOH)—, and a group of formula:

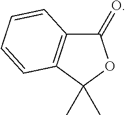

34. The polymer (PAES) according to claim 25, wherein the amount of monomer of formula (II) is at least 0.25% moles, with respect to the total number of moles of monomers.

35. The polymer (PAES) according to claim 25, wherein the amount of monomer of formula (II) is at most 2% moles, with respect to the total number of moles of monomers.

36. The polymer (PAES) according to claim 26, wherein the polymer (PAES) has a polydispersity index (Iₚ) of less than about 2.4.

37. The method according to claim 27, wherein the ratio of the equivalents of alkali metal (M) per equivalent of hydroxyl group (OH) of the monomer of formula (I) and the monomer of formula (II) [eq. (M)/eq. (OH)] ranges from about 1.03 to 1.25.
